(19) United States
(12) Patent Application Publication
(10) Pub. No.: US 2026/0149403 A1
(43) Pub. Date: May 28, 2026

(54) Electrical Working Device

(71) Applicant: Andreas Stihl AG & Co. KG, Waiblingen (DE)

(72) Inventors: Jan Lukas JACKENKROLL, Waiblingen (DE); Johann-Sebastian Renz, Gomaringen (DE)

(21) Appl. No.: 19/396,520

(22) Filed: Nov. 21, 2025

(30) Foreign Application Priority Data
Nov. 22, 2024 (DE) 10 2024 134 463.6

(51) Int. Cl. H02P 29/10; H02K 7/14; H02K 11/33; H02P 29/04

(52) U.S. Cl. CPC H02P 29/10; H02K 7/145; H02K 11/33; H02P 29/04

(57) ABSTRACT

An electrical working device includes an electric motor, a tool driven by the electric motor, a user-operated control element by which a target speed of the electric motor can be specified, a controller which controls an actual speed of the electric motor to the user-specified target speed and a limiter which is designed to reduce the actual speed independently of the controller as soon as the actual speed exceeds a first speed limit.

### CROSS REFERENCE TO RELATED APPLICATION

This application claims priority under 35 U.S.C. §119 from German Patent Application No. 102024134 463.6, filed November 22, 2024, the entire disclosure of which is herein expressly incorporated by reference.

### BACKGROUND AND SUMMARY

The invention is based on the objective of providing an electrical working device that is reliable.

The electrical working device has an electric motor, for example a brushless DC motor.

The electrical working device also has a tool driven by the electric motor. For example, the tool can be rotating or revolving.

The electrical working device also has a user-operated control element by means of which a target speed of the electric motor can be specified. The user-operated control element can be, for example, a linearly moving, swiveling, rotating, etc. control element. The control element can be colloquially referred to as a throttle.

The electrical working device also has a controller that controls an actual speed of the electric motor to the user-specified target speed.

The electrical working device also has a limiter which is designed to reduce the actual speed independently of the controller, i.e. overriding the controller, as soon as the actual speed exceeds a first speed limit. The controller and the limiter can be embodied as software, hardware, or a combination of these.

In one embodiment, the limiter is designed not to change the actual speed, i.e. not to reduce it, as soon as the actual speed falls below a second speed limit after exceeding the first speed limit. The second speed limit is typically lower than the first speed limit.

In one embodiment, the limiter is designed to reduce the actual speed in that the limiter initiates electric braking of the electric motor. Electric braking is typically carried out by appropriate control of the electric motor and can include recuperation.

In one embodiment, the limiter is designed to reduce the actual speed in that the limiter limits a torque caused by the electric motor and/or limits a current in the electric motor. The reduction of the torque can be achieved, for example, by reducing a torque-forming current.

In one embodiment, the limiter is designed to reduce the actual speed in that the limiter varies, in particular reduces, a control variable output by the controller, for example in the form of a target torque.

In one embodiment, both the controller and the limiter are operated with a predetermined cycle time, i.e. the controller and the limiter operate at discrete times. The limiter has a limiter cycle time that is shorter than a controller cycle time of the controller, in particular less than the controller cycle time by a factor of 10 or more. This enables a quick reaction to or prevention of overspeed.

In one embodiment, the first speed limit is lower than an overspeed limit, which depicts, for example, a speed above which a negative change in the electrical working device can occur.

In one embodiment, the second speed limit is greater than or equal to a user-specified maximum target speed and/or the second speed limit is lower than the first speed limit.

In one embodiment, the controller is a proportional integral (PI) controller.

In one embodiment, the electrical working device is an in particular battery-operated cut-off grinder or angle grinder. Alternatively, the electrical working device can also be a chainsaw, etc.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a highly schematic block diagram of an electrical working device according to an embodiment of the invention; and

FIG. 2 is a profile of a speed and a torque of an electric motor of the electrical tool shown in FIG. 1 and of operating states against time.

### DETAILED DESCRIPTION OF THE DRAWINGS

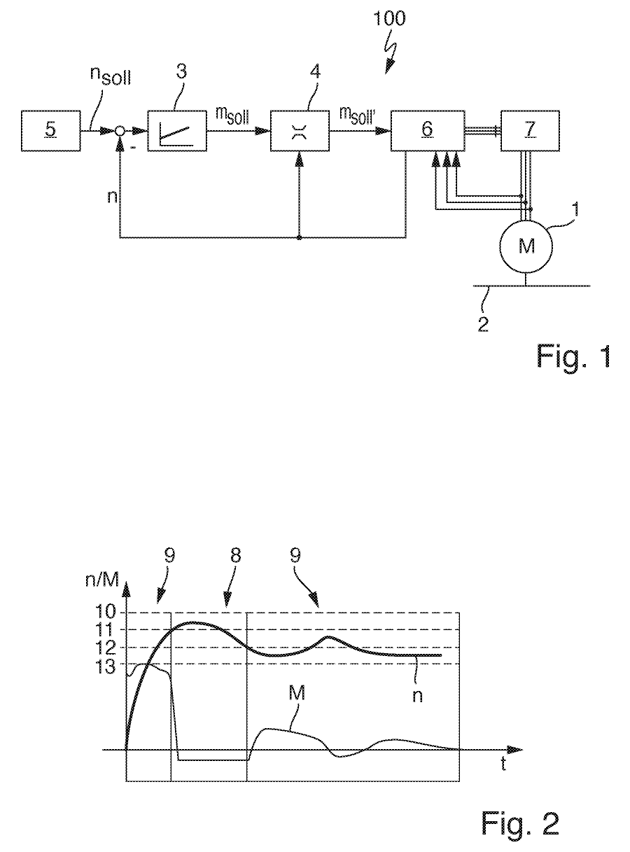

FIG. 1 shows a highly schematic block diagram of an electrical working device in the form of a cut-off grinder 100 with an electric motor 1.

FIG. 2 shows by way of example a time profile of the speed n of the electric motor 1 and a time profile of a torque M generated by means of the electric motor 1 during normal motor operation 9 and during braking operation 8.

With reference to FIG. 1, the electrical working device 100 has: an electric motor 1, a tool driven by the electric motor 1 in the form of a cutting disc 2, a user-operated control element 5 by means of which a target speed nₛₒₗₗ can be specified, a PI controller 3 which controls an actual speed n of the electric motor 1 to the user-specified target speed nₛₒₗₗ, a limiter 4 downstream of the PI controller, a motor controller 6 downstream of the limiter 4 and power electronics 7 controlled by the motor controller 6 and which control the electric motor 1.

The limiter 4 is designed to reduce the actual speed n independently of the controller 3 as soon as the actual speed n exceeds a first speed limit 11, see the braking mode 8 in FIG. 2. During the braking mode 8, the limiter 4 reduces the actual speed n by causing electric braking of the electric motor 1, i.e. causing a negative torque. To do this, the limiter 4 changes a torque control variable mₛₒₗₗ output by the controller 3 to negative values, for example, see FIG. 2. The control variable output by the limiter 4 is denoted as m_{soll’}.

The limiter 4 is designed not to change the actual speed n as soon as the actual speed n falls below a second speed limit 12 after the first speed limit 11 has been exceeded, see the transition to normal motor operation 9 in FIG. 2. Consequently, In this case m_{soll'} = m_{soll.}

The limiter 4 has a limiter cycle time that is significantly less than a controller cycle time of the controller 3.

The first speed limit 11 is lower than an overspeed limit 10, above which a negative change in the electrical working device 100 can occur. The second speed limit 12 is greater than a user-specified maximum target speed 13. The second speed limit 12 is lower than the first speed limit 11.

The PI controller 3 ensures a smooth start-up of the electrical working device 100.

In order to achieve the highest possible device performance, a very small speed range must be achieved between the user-specified maximum target speed 13 and the overspeed limit or rated speed limit 10.

The overspeed limit or rated speed limit 10, for example, results indirectly from a standard. In a normative test for all approved cutting discs of a working device, for example, a protective cover of the working device must not be damaged. The overspeed limit 10 is therefore the speed that must not be exceeded in order to ensure that the protective cover is not damaged in the normative test of a cutting disc approved for a particular machine. Cutting discs typically have a maximum cutting disc circumferential speed. A maximum spindle speed is calculated from this, wherein the cutting disc is connected to the spindle in a torsionally resistant manner, and the spindle is coupled to an output shaft of the electric motor via a gearbox. On the basis of the spindle speed, a motor speed is determined if the transmission ratio of the gearbox is known. This then defines the overspeed.

A wide variety of cutting discs or cut-off grinding discs can be used with the same machine. Consequently, there are different moments of inertia, for example due to lighter resin discs, heavier metal discs, and different degrees of wear of the discs, which in turn results in different tool weights, etc.

Traditionally, the controller 4 is tuned to a specific system, which is difficult in the present case due to the different moments of inertia.

An overspeed can occur, for example, when a user requests a maximum speed, i.e. goes full throttle, then the tool, for example the cutting disc, comes into contact with a workpiece, whereupon the machine speed collapses and the controller tries to increase the speed again, and then, while the controller is still trying to accelerate, the tool is pulled out of the cut again. This causes the speed to increase in a highly dynamic manner, wherein the controller cannot prevent the speed increase due to its inert dynamic properties.

The PI controller, which is supposed to ensure a smooth start-up of the machine, is not suitable for very fast/dynamic control in an upper speed range. This would require a different type of controller that can control very variably and quickly, but with the problem that due to the different tool moments of inertia, it is not possible to tune it to a specific system.

According to the invention, a combination is used of a PI controller for a smooth start-up of the electrical work device with an additional function, which can be implemented in software, for example, and limits the speed overshoots in such a way that they are not noticeable or are hardly noticeable to the user. In other words, there is no constantly changing acceleration and deceleration, as would be the case with the use of a controller that cannot control dynamically enough.

If the first speed limit of 11 is exceeded, the motor speed of the machine is reduced. If the speed falls below the second speed limit 12, normal motor operation is enabled again.

The following applies:

first speed limit 11 <= overspeed limit 10;

first speed limit 11 > second speed limit 12;

second speed limit 12 >= maximum speed 13 that the user can specify, which corresponds to a fully depressed throttle.

For example, the overspeed limit 10 can be 10400 revolutions per minute, the first speed limit 11 can be 10200 revolutions per minute, the second speed limit 12 can be 10000 revolutions per minute, and the maximum speed 13 can also be 10000 revolutions per minute, for example.

The limiter can, for example, reduce the motor speed by means of the following measures: electric braking, limiting the torque and/or motor current, defined negative battery current / recuperation current, motor controller consisting of a cascade controller, wherein the torque of the speed controller is limited by this function.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An electrical working device, comprising:
an electric motor;
a tool driven by the electric motor;
a user-operated control element by which a target speed of the electric motor is specified;
a controller which controls an actual speed of the electric motor to the user-specified target speed; and
a limiter which is designed to reduce the actual speed independently of the controller as soon as the actual speed exceeds a first speed limit.

2. The electrical working device as claimed in claim 1, wherein
the limiter is designed not to change the actual speed as soon as the actual speed falls below a second speed limit after exceeding the first speed limit.

3. The electrical working device as claimed in claim 1, wherein
the limiter is designed to reduce the actual speed in that the limiter causes electric braking of the electric motor.

4. The electrical working device as claimed in claim 1, wherein
the limiter is designed to reduce the actual speed in that the limiter limits a torque caused by the electric motor and/or limits a current in the electric motor.

5. The electrical working device as claimed in claim 1, wherein
the limiter is designed to reduce the actual speed in that the limiter changes a control variable output by the controller.

6. The electrical working device as claimed in claim 1, wherein
the limiter has a limiter cycle time that is less than a controller cycle time of the controller.

7. The electrical working device as claimed in claim 6, wherein the limiter cycle time is less than the controller cycle time by a factor of 10 or more.

8. The electrical working device as claimed in claim 1, wherein
the first speed limit is lower than an overspeed limit.

9. The electrical working device as claimed in claim 2, wherein
the second speed limit is greater than or equal to a user-specified maximum target speed and/or the second speed limit is less than the first speed limit.

10. The electrical working device as claimed in claim 1, wherein
the controller is a PI controller.

11. The electrical working device as claimed in claim 1, wherein
the electrical working device is a battery-operated cut-off grinder or angle grinder.
